(19) United States
(12) Patent Application Publication
(10) Pub. No.: US 2008/0040539 A1
(43) Pub. Date: Feb. 14, 2008

(54) METHOD AND SYSTEM FOR WRITING AND READING APPLICATION DATA

(75) Inventors: Nils Haustein, Soergenloch (DE); Stefan Neff, Bingen (DE); Ulf Troppens, Mainz (DE); Josef Weingand, Bad Bayersoien (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/832,805

(22) Filed: Aug. 2, 2007

(30) Foreign Application Priority Data
Aug. 9, 2006 (DE) 06118642.5

(51) Int. Cl. G06F 12/00

(52) U.S. Cl. 711/113

(57) ABSTRACT

The invention relates virtual tape systems. A method of controlling a cache controller is disclosed comprising the steps:
a) when writing current application data to a logical volume resident in said random-access cache;
b) maintaining surrounding cache storage location meta information—in most cases block addresses—about application data which was also written to the cache within a predetermined time surrounding of the current data, which is understood as adaptive read caching;
c) when reading (recalling) the current data from tape into the cache in response to an application request;
d) also reading respective surrounding application data according to the current data time surrounding from tape to cache in order to anticipate further reads to be performed later by the application.

### 1. BACKGROUND OF THE INVENTION

1.1. Field of the Invention

The present invention relates to backup solutions in electronic computing systems and in particular to a method and respective system for managing the storage of application data on a tape storage medium, wherein the application data is cached in a so-called “virtual tape system”, represented by a random-access storage medium, preferably a hard disk, before being written to tape or read from tape.

1.2. Description and Disadvantages of Prior Art

Such prior art system is described in G. T. Kishi “The IBM Virtual Tape Server: Making Tape Controllers More Autonomic”, IBM Journal of Research & Development, Vol. 47, No. 4, July 2003. With reference to FIG. 1, an application computer 10 hosts a user application 12, which maintains data that is regularly written on tape, and which is to be read sometimes from tape in order to be processed. The tape used is one or more of the tapes 17 A to 17 M, which are managed in a tape library 19. A cache server 14 has a large hard disk capacity 18 which is controlled by a cache controller 16. This disk cache 18 is used to cache the data before being read from or written to tape in order to provide an efficient access to the data in the storage system.

The term “physical volume” is used to denote a tape, whereas the term “logical volume” is used to denote a storage area in the disk cache 18. The storage manager operates transparently to the user application in a way that the logical volume is emulated as physical volume.

The above-mentioned prior art document discloses a storage subsystem which allows so called “volume stacking”, wherein multiple logical volumes stored in the disk cache 18 are automatically migrated, i.e. written to one physical volume. In this prior art the maximum size of a logical volume is a number of N times smaller than the capacity of a physical volume. N is in the range of several hundred.

The automatism for migration is that a logical volume once written by the user application is pre-migrated from disk-cache to physical volume (tape) immediately. Pre-migration means that there is a copy of the logical volume in disk cache 18 and on tape in tape library 19. The migration of the logical volume (logical volume resides on physical volume only and disappears from disk cache) is based on predetermined policies. These policies include usage (least recently used, LRU) and cache-preference groups. As long a logical volume resides in disk cache it is always accessed there allowing fast access compared to data retrieval times from a physical volume.

Data read access to a logical volume—for example triggered by a mount operation in the user application—does not require any manual intervention, it is done automatically. There are two major use cases: First, the logical volume is in disk cache 18: Then the I/O operation is performed using the data in disk cache. The mount operation is very quick. Second, the logical volume has already been migrated to the physical volume and has been deleted from disk cache 18 before. Then the entire logical volume is read from the physical volume (tape) to disk cache 18, and a subsequent I/O operation is performed using the data from disk cache.

The process of reading a logical volume from a physical volume is also referred to as recall. The recall operation is more time consuming and only tolerable when the size of logical volumes is small compared to the capacity of physical volumes. In other words, this design is not appropriate when there is a 1:1 size relation between the logical volume and the physical volume assuming that the size of a physical volume according to prior art can be 500 GB or more. With a 1:1 relation recall times would exceed hours and the user application 12 will have to wait hours for the data request. In a typical environment according to the prior art the logical volume size is between 400 MB and 4 GB, whereas the physical volume sizes are at 500 GB.

This prior art virtual tape emulation method offers another function called “fast-ready” mount, where the user application denotes a “scratch” logical volume mount for a write operation from the beginning of tape in order to reuse the data. The denotation of the “fast-ready” mount is placed in the actual mount request sent by the user application 12 to the cache controller. In this case the logical volume will not be retrieved from the physical volume but will just be allocated in disk cache.

A further prior art method is implemented in the IBM TS7510 (Centralized Virtual Tape). More details can be found for example in “IBM Virtualization Engine TS7510: Tape Virtualization for Open Systems Servers”, IBM RedBook SG24-7189-00, 10-17. In this prior art method the size of logical volumes is equal to the size of physical volumes. Thus, a 1:1 size relation is present. For example the logical volume size of an IBM TS1120 tape is 500 GB which is identical to the physical volume capacity of such a TS1120 tape.

The VirtualTape Library product generally available from FalconStor uses an approach for migrating a logical volume to a physical volume, called “Automatic Tape Caching”, where the virtual tape library (VTL) automatically moves (migrates) data from the disk cache 18 to the physical tape cartridge 17 based on certain policies. Accordingly, it discloses different approaches to recall this data residing on a physical volume to disk cache. This is similar to the approach outlined above for the IBM Virtual Tape Server.

The problem with this technology is, as tape technology according to prior art can store 500 Gigabytes (GB) of data on a single tape (TS1120), it may take up to 2-4 hours to migrate a 500 GB logical volume to a physical volume. The same is true for recalling data back into disk cache from tape. Although such long migration time raises already a significant time problem, the recall from tape back into disk cache is even more problematic as it takes the same amount of time, while the user is constrained to wait and can generally not work in the meantime as the data to be recalled from tape is the subject of his work.

The recall operation either copies the entire logical volume from a physical volume to disk cache or allows the application directly access the tape, but in a read-only mode. Copying the data from a physical volume to the disk cache 18 can take up to four hours. Allowing the application to directly access a tape eliminates the advantage of a virtualization because the physical resource is evident to the application.

Briefly, prior art tape caching allows the backup software to control all tapes no matter if the tape exists in a virtual form or if the tape is migrated to its physical counterpart. This VTL automatically redirects the backup data flow to the cache (new write) or to the physical tape (read, write append data) accordingly the VTL cache policy applied. With policies, it is possible migrating logical volumes to physical counterparts on a combination of following triggers: Tape Age, Storage pool capacity threshold, End of Backup, Tape Full and at a certain time.

This prior art design will create a bottleneck especially during combined host operations such as concurrent Read, Write Append and New Write because all of these operations require access to a physical tape. But in reality not all of these operations may need access to physical resources. For example, any kind of write operations must not use physical tapes initially as these operations can be directed to disk cache. For example, above mentioned VTL can have 256 logical devices and only five physical drives—the main reason to use tape virtualization is to reduce the number of required physical devices. The purpose of virtualization is to save scarce physical resources and utilize these most efficiently. The design of the VTL according to prior art will here be limited and requires for best performance and utilization theoretically the same amount of physical drives as logical devices are present. This makes the idea of virtualization obsolete.

Thus, in summary, the discussed prior art virtual tape emulations have some shortcomings. Considering the fact that purpose of virtualization is to save scarce physical resources and utilize these most efficiently. The first method discussed only works sufficiently well when the size of logical volumes is rather small compared to the physical volume where it is finally migrated to. The disadvantage is that the user application 12 needs to manage much more logical volumes. With the second discussed method read processing requiring recalls from physical tape either takes a long time or applies read-only restrictions. Both methods do not efficiently deploy the physical drives because they demand physical drives for operations which do not really require it—for example any kind of write operation.

1.3. Objectives of the Invention

It is thus an object of the present invention to provide a virtual tape system managing method facilitating fast and unrestricted read access to all data and managing physical resources more efficiently.

### 2. SUMMARY AND ADVANTAGES OF THE INVENTION

This object of the invention is achieved by the features stated in enclosed independent claims. Further advantageous arrangements and embodiments of the invention are set forth in the respective dependant claims. Reference should now be made to the appended claims.

The advantages of the presented invention are achieved by the fact that data blocks requested by a user application are in most cases correlated to data blocks which have been written consecutively in sequence. The statistical probability is high that a particular plurality of data blocks which were once written in that sequence are later again all together or nearly all together requested for a read in that sequence, because they may belong to one file written by the application at a certain time. Such plurality of data blocks may also comprise data blocks which have been written across multiple logical volumes. The method supports takes benefit from the fact that tapes are sequential I/O devices. It is proposed to direct data access to a cache when appropriate. This eliminates the need to access physical drives for certain operations. More precisely, all kind of write operations are preferably directed to a cache.

In addition, this invention contributes to the idea of virtualization by saving scarce physical resources and allowing access to virtual resources when appropriate.

With reference to the claims, according to its broadest aspect the present invention discloses a method for managing the storage of application data on a tape storage medium, preferably a single-reel tape, wherein said application data is stored in a random-access cache before being written to tape or read from tape, wherein the method is characterized by controlling a cache controller to perform the steps of:

a) when writing current application data to a logical volume resident in said random-access cache;
b) maintaining surrounding cache storage location meta information—in most cases block addresses—about application data which was also written to the cache within a predetermined time surrounding of the current data, which is understood as adaptive read caching;
c) when reading (recalling) the current data from tape into the cache in response to an application request;
d) also reading respective surrounding application data according to the current data time surrounding from tape to cache in order to anticipate further reads to be performed later by the application.

Adaptive caching means that, besides the requested data, also surrounding data is copied to cache in order to service subsequent read requests quickly. Surrounding data may be preceding or succeeding data relative to the requested data. The method according to the present invention analyzes certain parameters such as

a) the type of data access command,
b) the requested block address,
c) the preceding data access commands and
d) the data blocks written consecutively in a prior operation and derives the most appropriate caching strategy.

The present invention overcomes the shortcomings outlined above.

By way of recalling surrounding data pertaining to the read request instead of the entire logical volume or just the requested data allows an 1:1 relation between logical and physical volume and facilitates fast automatic access to data even when the logical volume is migrated to physical volume. Therefore, the present invention teaches a system and method for adaptive caching for I/O command processing.

Adaptive caching allows fast read access to data of a large logical volume without giving direct access to the physical tape or copying the entire logical volume from physical volume to cache. Adaptive caching allows an application access to data stored in a virtual tape system without major performance degradations, read-only restrictions or manual intervention regardless whether the data resides in cache or on physical tape.

By way of directing write operations to cache without recalling the data from physical tape or requiring access to physical tapes otherwise, even if the write operation appends data to an existing logical volume, this invention utilizes physical tape drives very efficiently.

A further advantageous feature according to prior art is to keep a “stub” file in the cache for a logical volume which has been migrated to a physical volume. The stub file contains some meta information as well as the first n data blocks including the volume header and label. The integer number n can be user adjustable and should at least include the data blocks including the volume header and volume label of the logical volume. A stub file for a particular logical volume allows satisfying read request of certain data areas from cache. Therefore, the data included in a stub file should at least contain the volume header and label, because this data is read more often and may precede a write operation.

### 3. BRIEF DESCRIPTION OF THE DRAWINGS

The present invention is illustrated by way of example and is not limited by the shape of the figures of the drawings showing schematic representations in which:

FIG. 1 illustrates structural elements of a prior art system environment including a tape library, a virtual tape system and a client computer implementing a user application the data of which is managed by those systems;

FIG. 2 shows in an environment analogue to FIG. 1 a new disk cache controller implementing a method in accordance with the present invention;

FIG. 3 illustrates the control flow of a WRITE command processing in a basic form used by a method in accordance with the present invention;

FIG. 4 illustrates the control flow of a WRITE command processing in an advanced form used by a method in accordance with the present invention;

FIG. 5 illustrates the control flow of an adaptive READ command processing used by a method in accordance with the present invention;

FIG. 6 illustrate the control flow of a LOCATE command processing used by a method in accordance with the present invention;

FIG. 7 illustrates a table storing essential control information used in a method in accordance with the present invention;

FIG. 8 illustrates the control flow to set the amount of data retrieved to an optimal value in accordance with the present invention;

FIG. 9 illustrates the structure of an SCSI WRITE command for sequential devices according the prior art (for improved clarity only);

FIG. 10 illustrates the structure of an SCSI READ command for sequential devices according to prior art (for improved clarity only;

FIG. 11 illustrates the structure of an SCSI LOCATE command for sequential devices according to prior art (for improved clarity only); and

FIG. 12 illustrates the structure of an SCSI SPACE command for sequential devices according to prior art (for improved clarity only).

### 4. DETAILED DESCRIPTION OF THE PREFERRED EMBODIMENT

With general reference to the figures and with special reference now to FIG. 7 a method in accordance with the present invention manages—that is creates, and maintains—a table 700 comprising meta information 33, 34, 35, 36. The meta information 33, 34, 35, 36 describes at which storage location further relevant information is stored, which stems from the same point in time as a current data set which is or has been stored on tape. Examples for such meta information are data block addresses, written in a consecutive timely sequence and other detailed information.

The table of FIG. 7 contains a volume ID 32 of the logical volume and the data block addresses 33 written in sequence in a form that only “from-block”, i.e. the start information and “to-block”, i.e. the end position information is stored. A timestamp 34 for consecutive blocks is also stored 106.

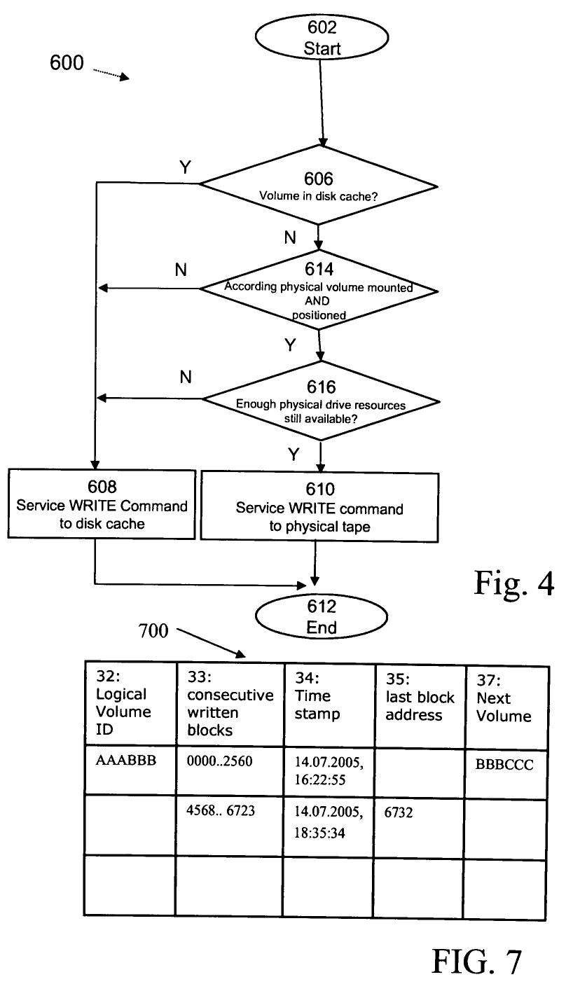

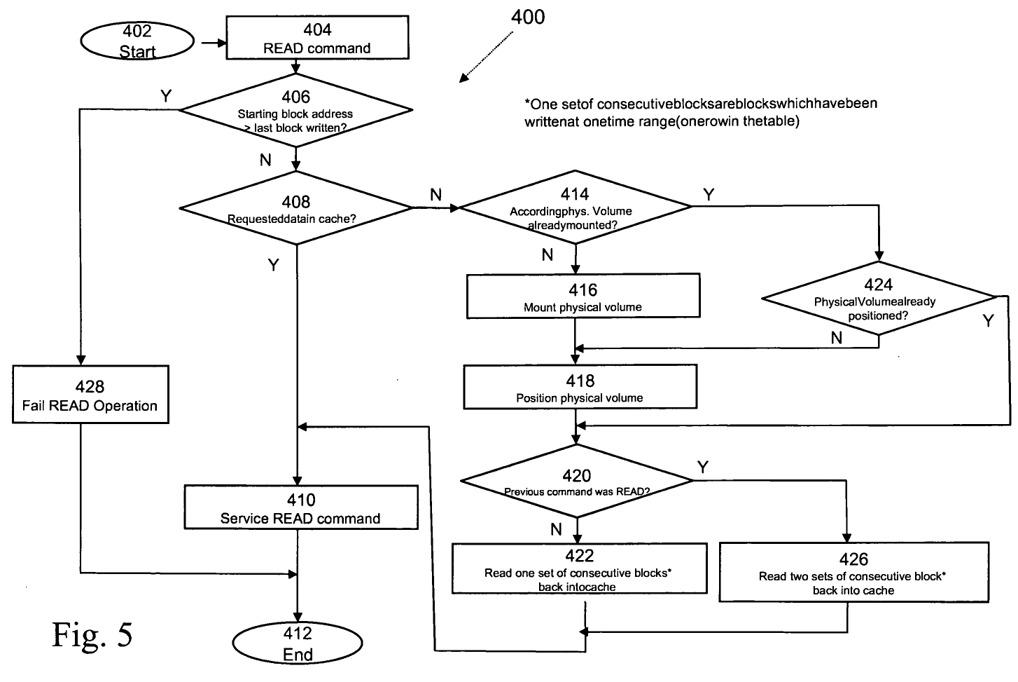

Further, the block address 35 of the last written data block is also stored for each volume. The last written block address 35 is used by the write command processing according to FIG. 5 (step 506) and by read processing FIG. 4 (step 406) to validate that a read or write request is not beyond the last written block address.

Typically for the invention, a logical volume 37 which has been written by the same application immediately after the logical volume 32 has been filled up, is also tracked in this table by indicating its volume ID in field 37. The background is that a user application may write data and thereby fill up one logical volume. Subsequently, it will mount a second new logical volume and continue to write data to the new logical volume. The data written to the end of the first volume and to the beginning of the new volume might be consecutive. Therefore it is valuable to store the information about consecutively written data blocks 33 across logical volumes. Thereby each logical volume can have a minimum of 0 and a maximum of 1 next volume 37. This allows identifying associations between two logical volumes which may contain associated, i.e. content-related data.

Each logical volume used in the virtual tape system might have at least one entry in the table 700. There might be more than one entry for each logical volume in this table 700 denoting multiple consecutive block ranges and time stamps. All other fields contain one and the same entry which is valid for the logical volume at a given time.

Table 700 is updated during each write operation (FIG. 5, step 509) for each volume where the written block addresses are accumulated. For example, if during a given time t the application writes blocks 0-9999, the table obtains the appropriate entry (0-9999 in field 33 of table 700). According to this preferred embodiment a time range comprises the time between the first write operation to the logical volume until there has been tracked a break of at least 1 minute in which no write operation occurred. This break indicates that the data written during this time belongs together, and thus stems from the same close application context, for example data from the same project, sales of the same store, account data of the same bank, etc.

In an alternate embodiment the break time can be a user-configurable parameter. With this embodiment the user can tune the timing of consecutive blocks depending on his specific environment and backup operations.

If the volume has been filled up during this time and there is a mount from the same application of another logical volume within 60 seconds, the other logical volume is associated with the filled volume and its volume ID is tracked in the field 37 “next logical volume”.

The application writing a logical volume can be identified dynamically by a WWPN and WWNN of the server and adapter where the application resides, or by the logical library which is assigned to the application. The World Wide Port Name (WWPN) is a unique identifier for each port in a storage area network (SAN). Thus an application residing on a server issues commands through a port of the server. This port has a unique identifier (WWPN) which can be used to identify the application. The World Wide Node Name (WWNN) is a unique identifier for the server where the application resides. Thus the WWNN of the server can also be used to identify an application. Both WWNN and WWPN are part of the I/O command sent by the application to the virtual tape system.

A logical library consists of a set of logical drives and logical volumes. The logical library can be assigned to the application and therewith a logical volume is implicitly assigned to an application.

When a volume is re-used, all entries are deleted from the table 700. Rewriting a logical volume is characterized by a write operation from the beginning of volume.

In an alternate embodiment, if the volume is not re-written from the beginning but somewhere in the “middle” of the tape media band, all records in the table are deleted which contain information beyond where the write operation started. Thus includes consecutive blocks 33 and time stamp 34. If in this case the volume is rewritten from the beginning all prior entries are deleted.

The method preferably assumes that the header and label of a logical volume (a so called “stub”, e.g. 4 KByte long) is always kept in cache 18. This allows satisfying label operations without mounting the associated physical volume. Many prior art backup software products require a volume label verification process before they actually write the tape “new”.

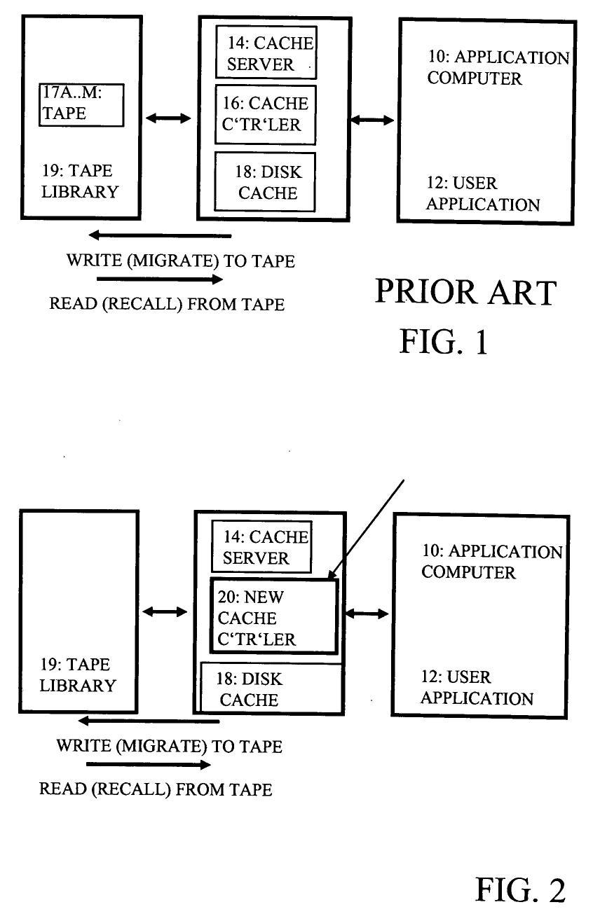

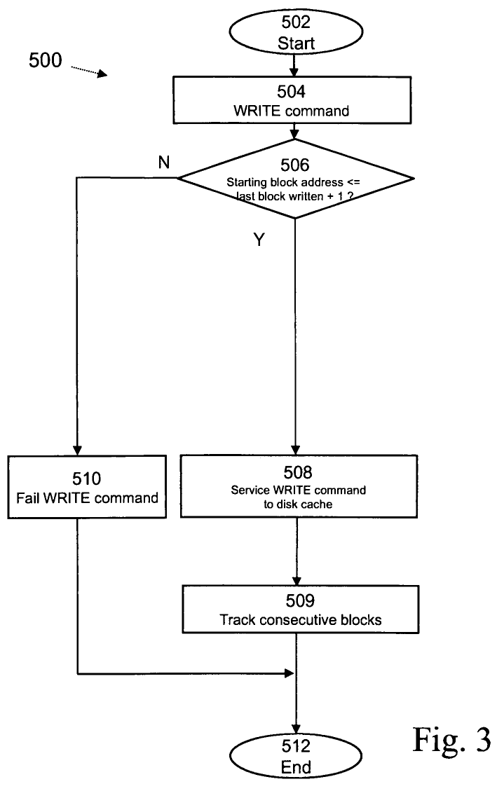

Next, and with references to FIGS. 3, 4, 5 and 6 flow charts and respective descriptions are given for write, read, locate/space, command processing of the system according to the present invention. It should be mentioned that a respective command (write, read, locate/space) is sent by an application computer 10 and respective user application 12 (FIG. 1) connected via a network to a system according to the invention. The network might be Storage Area Network based, for instance Fibre Channel or Internet SCSI (Small Computer System Interface; iSCSI).

A preferred control flow for basic Write operations is illustrated in FIG. 3 for a process 500 using the disk cache 18 in FIG. 2. FIG. 4 illustrates an enhancement of the basic write process 500. The process in FIG. 4 can substitute step 508 of the basic process in FIG. 3. The basic write process 500 starts at 502 and forwards control to 504 where the WRITE command is received.

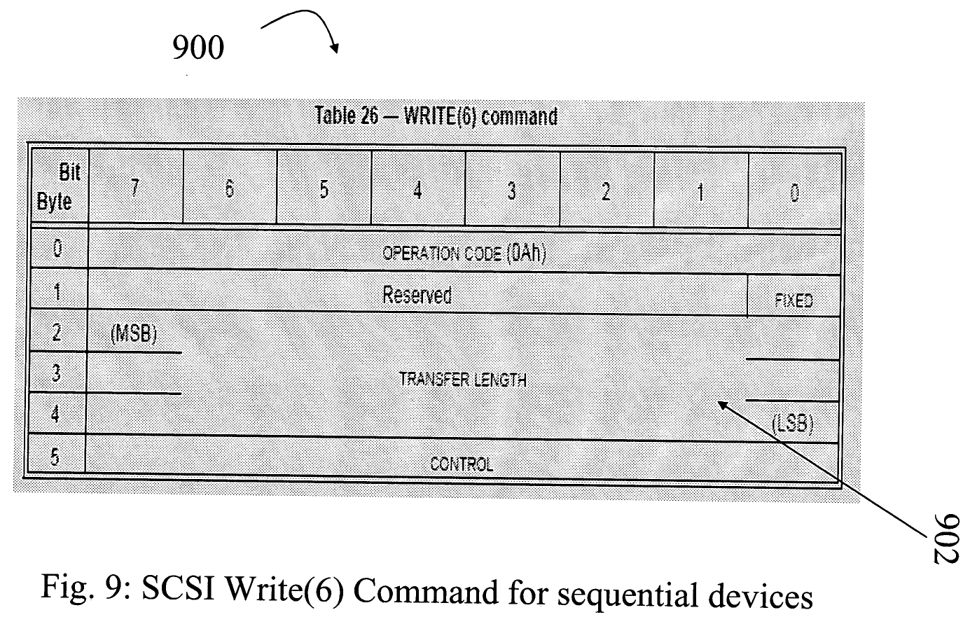

FIG. 9 presents an exemplary SCSI WRITE(6) command 900 for sequential devices. The SCSI WRITE command 900 includes the number of block to be written 902. The starting block address is equivalent to the position of the tape.

At a next step in 506 it is determined if the starting block address is equal or smaller than the last written block of the volume. The last written block address 35 (FIG. 7) of the volume is tracked in table 700 of this embodiment.

If the decision in step 506 is false, the WRITE Command will fail in step 510 and end the process in 512. Otherwise, the write command is serviced to disk cache in step 508. Step 508 can also be replaced by an advanced process 600 illustrated in FIG. 4. Subsequently, the written block addresses are tracked in step 509. Tracking of the written blocks may eventually result in an update of table 700 item 33 and 34. The process ends in step 512.

A preferred algorithm for advanced Write operations is illustrated in FIG. 4, where an advanced logic for the write command processing is introduced. This logic takes into account the state of the physical volume where the logical volume may reside on. This logic facilitates write operations directly to tape under certain conditions. The process in FIG. 4 can substitute step 508 of FIG. 3.

The process 600 starts at 602 and forwards control to 606 where it is checked if the volume is already or still in disk cache; if yes (“Y”) the write is serviced to disk cache 608 and the process 600 ends in 612. If the answer from test 606 for the volume in disk cache is “NO” (“N”), the process forwards control to next step 614 where it is determined if the according physical volume is already mounted and positioned. If not (“N”), the write is serviced to disk cache 608 and the process 600 ends in 612. If the answer from 614 for the physical volume already mounted and positioned is “YES” (“Y”), a next decision depicted in box 616 checks if still enough physical drives (resources) are available; if not (“N”), the write is serviced to disk cache 608 (which calls process 500) and the process 600 ends in 612. If the answer from test 616 is true (“Y”), a next step 610 services the write command directly to physical tape. Finally, the end 612 of process 600 is reached in step 612. Step 612 may finally find its continuation in step 509 of process 500 (FIG. 3), where the consecutively written blocks are tracked.

Tracking the consecutively written block numbers in step 509 means that the process accumulates all block addresses which have been written in a certain time. The time is variable and denoted from the time the first block has been written until a pause of longer than 1 minute occurs. Therefore, the respective steps in processes 600 and 500 keep a temporary table of the written blocks and a time stamp telling when the write command was received. If there is a pause of preferably more than 1 minute between the consecutive write commands, the actual list of block address ranges is written to item 33 in table 700 for the processed logical volume item 32. The timestamp for the last written block is also updated in item 34 of table 700. The block address of the last block is written to item 35 of table 700. If the last sequence of blocks 33 has been written to a new tape which has been immediately mounted after a prior tape, then item 37 in FIG. 7 is updated with the ID of this new volume.

With this inventive method for write processing scarce physical resources are rested because all write operations are directed to disk cache. In addition the inventive method enables the quick read processing even for a 1:1 relation of logical and physical volumes by memorizing the data block addresses which have been written in one time range by one application. This memorized data is used for read processing to enable fast read from disk cache, saving scarce physical resources.

The preferred control flow for READ operations is as follows: FIG. 5 illustrates the control flow of a process 400 for a preferred READ operation including the inventive feature of the adaptive read caching of the present invention.

In general, the READ operation is performed from the disk cache if the associated logical volume is in the disk cache. Otherwise, if the associated logical volume is not in disk cache, the READ operation requires the associated physical volume to be mounted and only required data is read off the physical volume to disk cache. This is done in a quick and efficient manner. The process of reading required data pertaining to a logical volume from a physical volume is also referred to as “Recall”. The Read process 400 starts at mark 402 and forwards control to 404, where the Read command is received.

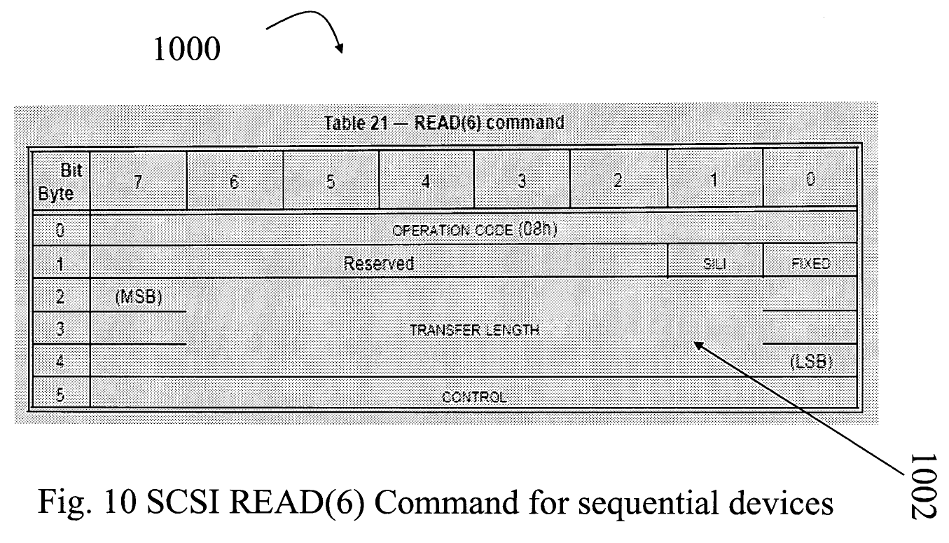

FIG. 10 presents an exemplary prior art SCSI READ(6) command used for sequential devices. The SCSI READ command 1000 defines the number of blocks 1002 to be read. The starting block address to where the first block is read is equivalent to the current position of the tape.

In step 404 the starting block address and the number of blocks 1002 to be read are identified from the READ command 1000. Then control continues to step 406 where it is determined if any block address to be read is “behind”, i.e. has a larger block address compared to the last block 108 which has been written for this logical volume. The last written block address 108 is stored for each logical volume as part of the write processing in item 35 of table 700.

If the decision in step 406 is true (“Y”), the process will flow to step 428 and will fail the READ operation with an error because the read command was attempting to read behind the last written block. Then control is forwarded to step 412, where the process ends. If the decision in step 406 is false (“N”), then in step 408 it is determined if the requested block addresses of the logical volume is in disk cache. If that is true (“Y”), and the requested data is in disk cache, then in step 410 the read command is serviced meaning that the data requested by the read command is sent to the requesting application. After that in step 412 the process ends.

If the decision in step 408 is false (“N”), then a recall from tape is required and the process forwards control to step 414 to check, if the respective physical volume is already mounted. If the volume is not (“N”) already mounted, the process continues to step 416 to mount the physical volume and to step 418 to position the respective physical volume identified by a respective ID. If the respective physical volume was already mounted in step 414, then a check is required in step 424 testing, if physical volume is already positioned.

If the decision in step 424 is NO (“N”), the process forwards control to step 418 where the physical volume is positioned to the position specified by the starting block address included in the read command received in step 404. From step 418 the process forwards control to step 420—explained later below.

Otherwise—if the physical volume was already positioned in step 424, the process moves on to the next step 420, where a check is performed testing if the previous command was a Read. For this purpose the process 400 keeps a history of the last ten commands performed for each logical volume. If the previous command was a read and the answer in step 420 is YES (“Y”), the program continues to step 426 where two sets of consecutive written blocks are read back (recalled) into disk cache. Two sets of consecutive blocks comprise all data blocks which are written in two consecutive time ranges to one or two (spawn) logical volume.

The information about consecutively written blocks is retrieved from table 700, item 33 for a given logical volume 32. If the answer from step 420 is NO (“N”)—because the previous command was not a read command, only one set of consecutive written blocks is read back into disk cache in step 422. One set of consecutive blocks comprises all data blocks which are written in one time range to one or two (spawn) logical volume(s). Steps 422 and 426 can be performed due to the fact that the cache controller maintains surrounding cache storage location meta information about application data. Surrounding cache storage location meta information refers to a set of block addresses which have been written within a certain time range.

The write process 500 in FIG. 5 describes the tracking of this surrounding cache storage location meta information according to this invention. The fact that block addresses are written and read sequentially from tapes is advantageous.

Steps 422 and 426 continue to step 410 where data requested by the read command received in step 404 is sent to the application. From step 410 the process forwards control to step 412 where the read command is finished. This may include sending an ending status to the application. The process ends in step 412.

The difference between step 426 and step 422 is that more data is read back to disk cache in step 426, if the previous command was a read command. The rationale is that multiple read commands in a sequence are performed by the application and therefore the process 400 reads more data back in to disk cache in order to service subsequent read commands with data from disk cache. This is much faster and efficient because the physical volume is already mounted and positioned. It is much more efficient and less time consuming to read many continuous blocks while the tape is running than reading one blocks at a time. Reading one block at a time would result in a start-stop mode of the tape drive which consumes more time and energy.

The extra amount of data which is read in step 426 compared to step 422 might be user-configurable. In the given example two times more data is read in step 426 compared to step 422, this can also be more, but should preferably be not less.

It is obvious that the starting block address which is read from disk cache in step 422 and 426 is equal to the starting block address given by the read command in step 404. Thereby the starting block address might be within a set of consecutive blocks 33, which is memorized in table 700. Furthermore, if the blocks to be read specified by the read command exceeds one set of consecutive blocks, another (additional) set of consecutive blocks including the requested blocks is read from physical tape.

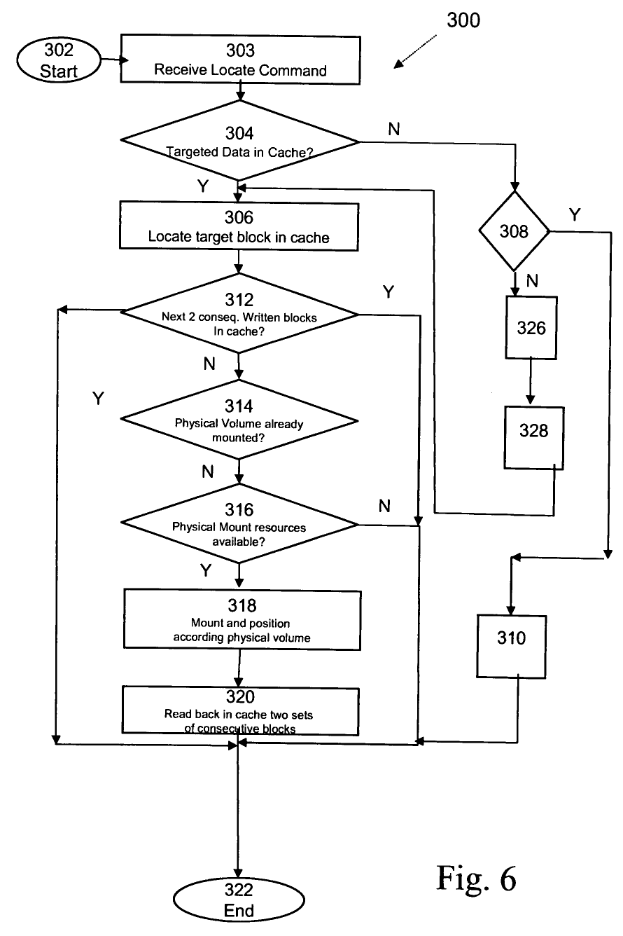

A preferred control flow for Locate operations is as follows FIG. 6 illustrates a process 300 implementing the locate operations according to a preferred embodiment of the invention. This operation requests the tape drive to position the read/write head at a particular position of the tape storage medium.

A novel feature for the implementation of the locate command is that more or less data might be recalled from the physical volume depending on the availability of physical tape drives in the tape library 19. Normally the locate command will not recall any data but just position the tape. According to one embodiment of this invention it is assumed that the next operation after the locate command or after a space command will be a read command. Therefore the present invention recalls some data beyond the destination block included in the locate command to disk cache so that the subsequent read command can be serviced quickly from disk cache. The amount of data to be recalled is essentially defined by the sequence the data was written (consecutive blocks).

The process starts at step 302 and step 303 where a LOCATE or SPACE command is received in the cache controller. Both commands request the logical to be positioned at a destination block address. The LOCATE command specifies the destination block address relative to the beginning of tape where the SPACE command specifies the destination address relative to the current position (block address) of the tape.

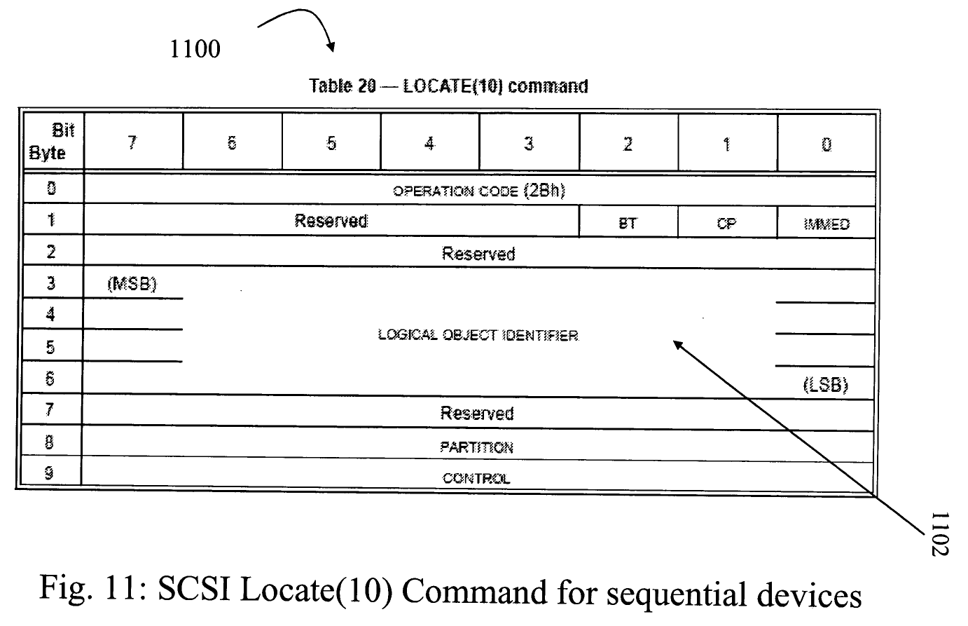

FIG. 11 illustrates a prior art SCSI LOCATE(10) command for sequential devices. The LOCATE command 1100 includes a “logical object identifier” field 1102 designating the destination block address. This is the address where the tape is requested to be positioned relative from the beginning of tape.

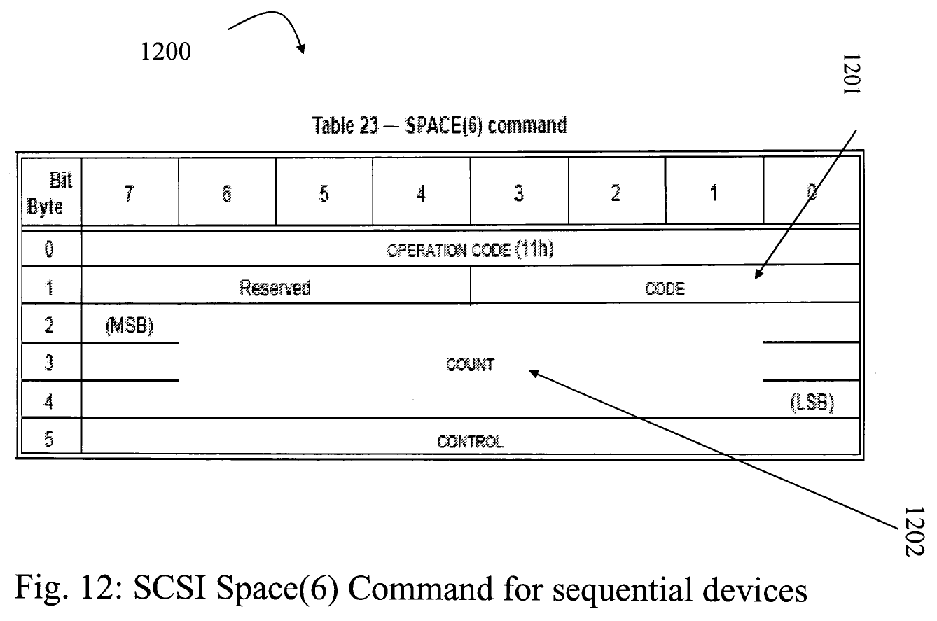

FIG. 12 illustrates a prior art SCSI SPACE(6) command for sequential devices. The SPACE command 1100 includes a “count” field 1202 designating the number of blocks to be positioned relative to the current position of tape. Note, the destination block address can also be a number of a filemark on tape. Field “code” 1201 designates whether the “count” field 1202 designates a count of filemark or a count of block addresses to be positioned. Both commands (SPACE and LOCATE) cause a change of the tape position.

From step 303 the process continues to step 304 where a check is performed whether the data associated with the destination block given by the LOCATE or SPACE commands 1100, 1200 and derived from the field 1102 or 1202 is already in disk cache. If the decision in step 304 is yes (“Y”) the process continues to step 306 explained later. If that is not the case (“N”), then the control flow follows the path to step 308 to verify whether the targeted block is not behind the last written block address, which is memorized in table 700 as item 35 for a given logical volume 32. If the targeted block is behind the last valid block (“Y”), then the controller logic will fail the Locate Operation in step 310 and finish the process in step 322.

If the targeted block is not behind the last valid block (“N”) per step 308, then control is forwarded to step 326 to mount the according physical volume and position the targeted block on physical volume.

Then the process forwards control to step 328 for reading back (recall) one set of consecutive written blocks to disk cache. One set of consecutive blocks comprises all data blocks which are written at one time range to one or two (spawn) logical volume. After completion of the recall operation in step 328 the process forwards control to step 306 where the (just recalled) target block data is located in disk cache.

According to an alternate embodiment the locate operation can be finished with step 306 by sending a completion message for the locate command received in step 303 to the application. In our preferred embodiment the process 300 continues with the objective to make more predictions for subsequent commands.

From step 306 the process continues to step 312, where a decision is made whether the next two sets of consecutive written blocks are in disk cache. This decision is based on the information stored in item 33 of table 700. If yes “Y”, then the process moves to the ending step 322. Otherwise, the process forwards control to step 314 where it is checked whether the respective physical volume is still or already mounted in a physical device.

If the decision in step 314 is true (“Y”), the controller positions the physical tape in step 324 and reads back (recall) two more sets of consecutive written data 320 in disk cache before the process is terminated in step 322.

If the decision in step 314 is false (“N”), the process continues to step 316 where a check is performed whether enough physical mount resources are available at that time. If not (“N”), the process forwards control to the ending step 322. If the decision in step 316, however, is yes (“Y”), then the process forwards control to step 318, where the according physical volume controlled to be mounted and positioned.

From step 318 the process forwards control to step 320, where two more sets of consecutive written data are read back to disk cache. Two sets of consecutive blocks comprises all data blocks which are written in two consecutive time ranges to one or two (spawn) logical volume.

From step 320 the process forwards control to the ending step 322, where the locate command is finished. This may include sending an appropriate notification to the application (see ref. 12 in FIGS. 1, 2).

It is obvious that the starting block address which is read from disk cache in step 328 and 320 is equal to the destination block address given by the locate command in step 303. Thereby the starting block address might be within a set of consecutive blocks 33, which is memorized in table 700.

The difference between step 328 and step 320 is that more data is read back to disk cache in 320 if the physical volume is mounted. The rational for this is that reading (recalling) more data of the mounted and positioned and streaming physical volume is quick and the data recalled can be used to satisfy a subsequent read operation with data from disk cache. It contributes to utilize physical resources efficiently by recalling more data than actually needed but which may be needed by subsequent commands.

The method enables the 1:1 relation of logical volumes to physical volumes because it retrieves data from physical volume to disk cache allowing subsequent read operations to be serviced with data from disk cache. In addition this method contributes to save physical tape drive resources by recalling more data then required while the tape drive is in streaming mode. This avoids start and stops of the tape drive which is time and energy consuming.

With the inventive method for read processing the size of a logical volume within a virtual tape system does not affect the read processing. Even with a 1:1 relation between a logical and physical volume read processing will not take hours but just a few minutes which is acceptable in a tape environment. This is because this invention does not recall the entire logical volume to disk cache but just as much data as needed by the current read request plus surrounding data to satisfy subsequent read request with data from disk cache. Thus subsequent read commands can be serviced with data from disk cache and are therefore performed quickly. In addition, subsequent read commands do not require access to scarce physical resources.

The amount of data recalled in steps 320, 328 of the locate process 300 and steps 422, 426 of the read process 400 might be high. If this amount of data to be retrieved exceeds a certain limit the recall operation may take a long time resulting in the user application to wait a long time for the completion of a command. Therefore it is useful and appropriate to implement a method step setting the amount of data being recalled to a maximum value.

The maximum amount value is preferably defined by a maximum amount of time a recall can take.

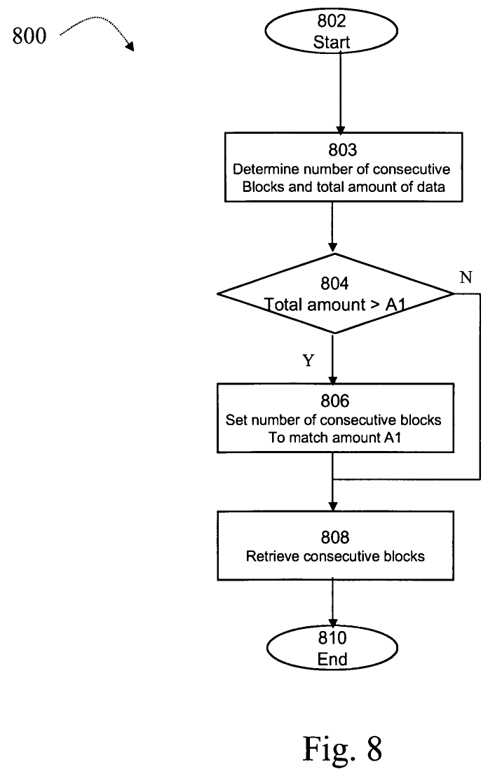

Process 800 in FIG. 8 describes such a process. This process replaces the steps recalling data. Process 800 starts at step 802 which is invoked by steps 320, 328 of locate process 300 or steps 422, 426 of read process 400. The control flow continues to step 803 where the amount of consecutive blocks and the amount of data is determined. The amount of data is simply calculated by: (number of blocks×block size). If the amount of data exceeds a predefined threshold A1 in step 804, the process continues to step 806 which sets the number of consecutive blocks to match the amount of data A1. The process continues to the next step 808 explained later. If the decision in step 804 yields that the amount of data is lower than the predefined threshold A1, the process continues straight to step 808. In step 808 the data addressed by the set of consecutive block addresses is being recalled from tape to disk cache. The process ends in step 810. This may return the control to the appropriate steps in process 300 and 400.

The predefined threshold A1 defines the maximum amount of data which can be recalled in a reasonable amount of time. The reasonable amount of time a recall can take is a user-configurable parameter. The default value shall be set to 5 minutes since 5 minutes are typical timeout values in a tape environment. The threshold A1 is calculated based on the maximum allowable time Tₘₐₓ and the I/O rate Iₜₐₚₑ of the physical tape drives (eqn. 1).

A1=Iₜₐₚₑ×Tₘₐₓ (eqn. 1)

The parameter I/O rate Iₜₐₚₑ is based on the physical tape drive technology and the connectivity to the tape drive. This parameter can by user-configurable. In an alternate embodiment the parameter Iₜₐₚₑ is dynamically measured by the system according to the present invention. This dynamic measurement of the I/O rate relates to measure the amount of data which is read from a physical tape drive in a given time. This way the system according to the present invention adopts the current I/O rate for each drive to calculate the maximum amount of data being recalled.

For example, if the current tape drive technology is LTO-3 (Linear Tape-Open) allowing for an sustained I/O rate of 40 MB/sec, the predefined threshold A1 might be set to 12 GB because 12 GB can be retrieved within 5 minutes (300 seconds) at the given I/O rate (40 M/s×300 s=12.000 MB).

The present invention can be realized in hardware, software, or a combination of hardware and software. A tape storage management tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;
b) reproduction in a different material form.

1. A method for writing and reading application data, wherein said application data is stored in a random-access cache (18) before being written to or read from a tape storage (17), and wherein said application is executed by a data processing system,
the method characterized by the steps of:
when writing (504) current application data from said random-access cache to said tape storage, creating meta data (33, 34, 35, 37) for said current application data in said random-access cache and maintaining (509) said meta data during a predetermined time limit;
when reading (404) stored application data from said tape storage in response to an application request also reading (422, 426) additional application data from said tape storage, whereby said additional application data is selected using meta data eventually found for said stored application data in said random-access cache, and writing said stored application data and said additional application data to said random-access cache.

2. The method according to claim 1, wherein said predetermined time limit is in the range of 1 minute.

3. The method according to claim 1 or 2, wherein the data in said random-access cache is organized in form of logical volumes, and wherein said tape storage comprises multiple physical volumes.

4. The method according to claim 2 or 3, wherein a stub file is maintained in said random-access cache comprising an indication that a logical volume has, or has not yet been migrated to a physical volume.

5. The method according to the preceding claims, further comprising the step of:
when a write operation appending data to an existing logical volume is issued by said application, said random-access cache is operated without recalling data from said tape storage.

6. The method according to the preceding claim, wherein said write operation is performed on a physical volume if the physical volume is mounted and positioned when said write operation is issued.

7. The method according to any one of the preceding claims, wherein data is recalled from a physical volume (17) to said random-access cache as a result of a locate command in order to predict and service subsequent read commands with data from said random-access cache.

8. The method according to the preceding claim, wherein more data is recalled if said physical volume is mounted and positioned at the time said locate command is issued.

9. The method according to any one of the claims 3 to 8, wherein surrounding data (37) is tracked in said meta information which may reside on a next logical volume.

10. The method according to any one of the claims 3 to 9, wherein logical volumes are assigned to said application based on a World Wide Port Name and a World Wide Node Name of said data processing system.

11. The method according to any one of the preceding claims, wherein a maximum amount of data to be recalled is dynamically calculated (803, 804, 806, 808) based on a predetermined maximum tolerable recall time.

12. A tape storage subsystem having a virtual tape emulation system with a cache controller (16) maintaining a random-access cache, said cache controller comprising means for performing the method according to any of the claims 1 to 11.

13. A computer program comprising computer program code portions for performing the method of any of the claims 1 to 11 when said computer program code portions are executed on a computer.

14. A computer program product stored on a computer usable medium comprising the computer program of claim 13.
